(19) United States
(12) Patent Application Publication
(10) Pub. No.: US 2018/0144757 A1
(43) Pub. Date: May 24, 2018

(54) METHOD AND APPARATUS FOR GENERATING BITSTREAM FOR ACOUSTIC DATA TRANSMISSION

(71) Applicant: Electronics and Telecommunications Research Institute, Daejeon (KR)

(72) Inventors: Seung Kwon Beack, Daejeon (KR); Jongmo Sung, Daejeon (KR); Mi Suk Lee, Daejeon (KR); Young Ho Jeong, Daejeon (KR); Tae Jin Lee, Daejeon (KR); Sang Won Suh, Daejeon (KR)

(73) Assignee: Electronics and Telecommunications Research Institute, Daejeon (KR)

(21) Appl. No.: 15/820,852

(22) Filed: Nov. 22, 2017

(30) Foreign Application Priority Data
Nov. 23, 2016 (KR) 10-2016-0156776
Feb. 21, 2017 (KR) 10-2017-0022861

(51) Int. Cl. G10L 19/16; G06F 17/22

(52) U.S. Cl. CPC G10L 19/167; G06F 17/2252

(57) ABSTRACT

Disclosed is a bitstream generation method performed by an acoustic data transmission (ADT) encoder, the method including receiving a first audio signal, receiving additional information converted into a bitstream, and transmitting a second audio signal obtained by inserting the bitstream into the first audio signal, to an ADT decoder.

### CROSS-REFERENCE TO RELATED APPLICATION(S)

This application claims the priority benefit of Korean Patent Application No. 10-2016-0156776 filed on Nov. 23, 2016 in the Korean Intellectual Property Office and Korean Patent Application No. 10-2017-0022861 filed on Feb. 21, 2017 in the Korean Intellectual Property Office, the disclosures of which are incorporated herein by reference for all purposes.

### BACKGROUND

### 1. Field

One or more example embodiments relate to method and apparatus for generating a bitstream for acoustic data transmission and, more particularly, to method and apparatus for formatting a bitstream that is inserted in an audio signal for transmitting additional information.

### 2. Description of Related Art

Acoustic data transmission technology may include an encoder for inserting additional information into an audio signal and a decoder for extracting the inserted additional information.

When transmitting the additional information based on acoustic data transmission technology, a distortion may occur in an acoustic channel and the transmitting may be performed inefficiently.

Accordingly, converting the additional information into a bitstream may be required to solve the distortion in the acoustic channel and efficiently transmit the additional information.

### SUMMARY

An aspect provides a bitstream structure of acoustic data inserted into an audio signal to transmit additional information through an acoustic channel and a bitstream related thereto.

Another aspect also provides a bitstream synchronization method to output additional information using a bitstream of an audio signal.

Still another aspect also provides a bitstream structure for effectively transmitting additional information and effectively handling a distortion in an acoustic channel.

According to an aspect, there is provided a bitstream generation method performed by an acoustic data transmission (ADT) encoder, the method including receiving a first audio signal, receiving additional information converted into a bitstream, and transmitting a second audio signal obtained by inserting the bitstream into the first audio signal, to an ADT decoder.

When the additional information is text information, a text type bitstream for transmitting the text information may be generated.

When the additional information is table index information, a table index type bitstream for transmitting the table index information may be generated.

When the additional information is time information of content, a time information type bitstream for transmitting the time information may be generated.

According to another aspect, there is also provided a bitstream playing method performed by an ADT decoder, the method including receiving, from an ADT encoder, a second audio signal obtained by inserting additional information converted into a bitstream into a first audio signal, extracting the bitstream from the second audio signal, and playing additional information by performing conversion on the extracted bitstream.

When the inserted additional information is text information, a text type bitstream for transmitting the text information may be generated.

When the inserted additional information is table index information, a table index type bitstream for transmitting the table index information may be generated.

When the inserted additional information is time information of content, a time information type bitstream for transmitting the time information may be generated.

According to still another aspect, there is also provided an apparatus for generating a bitstream, the apparatus including a processor configured to receive a first audio signal, receive additional information converted into a bitstream, and transmit a second audio signal obtained by inserting the bitstream into the first audio signal, to an ADT decoder.

When the additional information is text information, a text type bitstream for transmitting the text information may be generated.

When the additional information is table index information, a table index type bitstream for transmitting the table index information may be generated.

When the additional information is time information of content, a time information type bitstream for transmitting the time information may be generated.

According to another aspect, there is also provided a bitstream playing apparatus a processor configured to receive, from an ADT encoder, a second audio signal obtained by inserting additional information converted into a bitstream into a first audio signal, extract the bitstream from the second audio signal, and play additional information by performing conversion on the extracted bitstream.

When the inserted additional information is text information, a text type bitstream for transmitting the text information may be generated.

When the inserted additional information is table index information, a table index type bitstream for transmitting the table index information may be generated.

When the inserted additional information is time information of content, a time information type bitstream for transmitting the time information may be generated.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an overall process according to an example embodiment;

FIG. 2 is a diagram illustrating a structure of a text type bitstream according to an example embodiment;

FIG. 3 is a diagram illustrating a structure of a table index type bitstream according to an example embodiment;

FIG. 4 is a diagram illustrating a structure of a time code type bitstream according to an example embodiment;

FIG. 5 is a diagram illustrating a syntax of adt_data_extractor according to an example embodiment;

FIG. 6 is a diagram illustrating a definition of payload_available according to an example embodiment;

FIG. 7 is a diagram illustrating a syntax of preamble_sync according to an example embodiment;

FIG. 8 is a diagram illustrating a syntax of adt_data_frame according to an example embodiment;

FIG. 9 is a diagram illustrating an example of configuring a type of info bitstream with respect to a table type {001} according to an example embodiment;

FIG. 10 is a diagram illustrating a syntax of GetTextHeader according to an example embodiment;

FIG. 11 is a diagram illustrating a syntax of GetTableHeader according to an example embodiment;

FIG. 12 is a diagram illustrating a syntax of TextPayloadData according to an example embodiment;

FIG. 13 is a diagram illustrating a syntax of TablePayloadData according to an example embodiment; and

FIG. 14 is a diagram illustrating a syntax of TimecodePayloadData according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

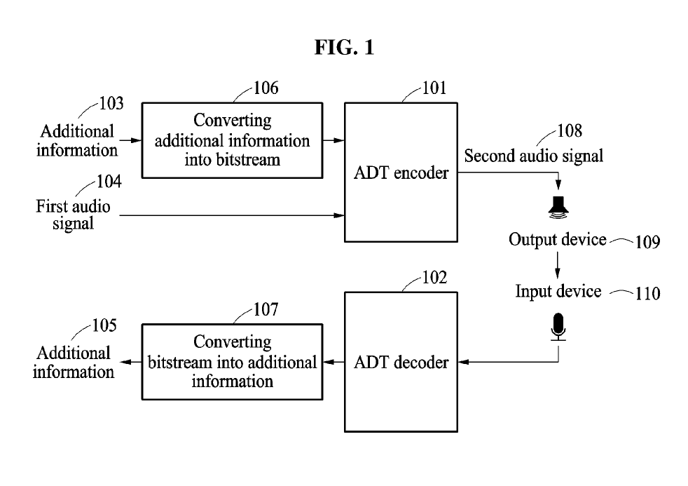

FIG. 1 is a diagram illustrating an overall process according to an example embodiment.

Acoustic data transmission (ADT) technology may effectively handle stable transmission of additional information and distortion in an acoustic channel. The ADT technology may include encoder technology for inserting acoustic data into an audio signal and decoder technology for extracting acoustic data.

Acoustic data may be a type of additional information being converted into a bitstream in order to be inserted into an audio signal. That is, the acoustic data may be a type of additional information being converted into a bitstream in order to be transmitted through an acoustic channel.

Additional information may be classified into two types. A first type may be additional information expressed by a bitstream such as text data, table index, and time code data. The additional information corresponding to the first type may be inserted into an audio signal. A second type may be additional information expressed by index data for identifying contents. The additional information corresponding to the second type may be extracted from an audio signal in general.

An ADT encoder 101 may generate a second audio signal 108 obtained by inserting additional information 103 converted into a bitstream into a first audio signal 104. In this example, the inserted additional information 103 may minimize degradation in a sound quality of the first audio signal 104.

The second audio signal 108 may be output through an output device 109 such as a speaker. An acoustic channel may be a physical space in which the second audio signal 108 is transmitted between an input device 110 and the output device 109. A distortion occurring in the acoustic channel may include noise distortion and reverberation distortion. The noise distortion may occur due to ambient noise. The reverberation distortion may occur due to a reflected sound. The additional information 103 may be able to withstand such distortion in the acoustic channel.

The second audio signal 108 may be input to an ADT decoder 102 through the input device 110 such as a microphone. The ADT decoder 102 may extract the bitstream from the second audio signal 108 and convert the bitstream into additional information 105. The acoustic data may be extracted by the ADT decoder 102 based on a structure of bitstream. In this example, the structure may vary based on a type of additional information because a format of transmitted acoustic data is obtained from the structure of the bitstream.

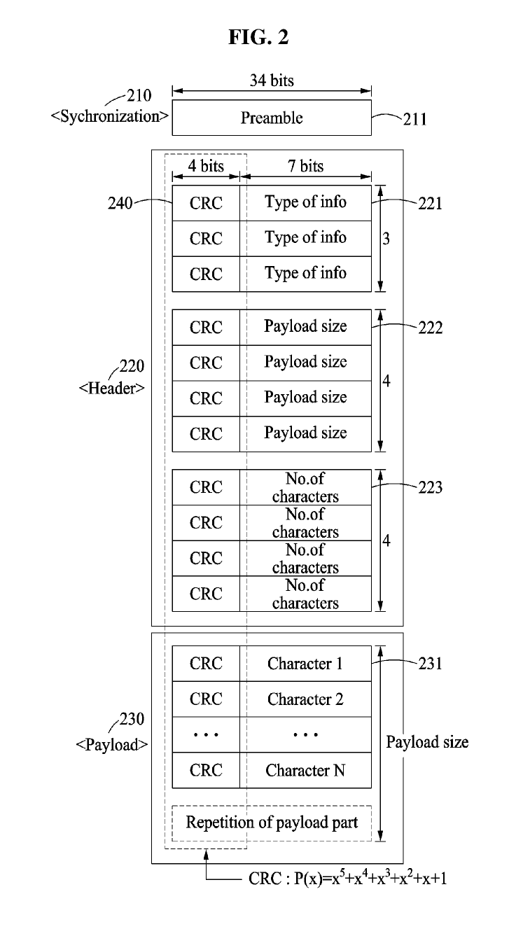

FIG. 2 is a diagram illustrating a structure of a text type bitstream according to an example embodiment.

A text type bitstream may include a synchronization area 210 in charge of synchronization, a header area 220 in charge of a header, and a payload area 230 in charge of a payload.

The synchronization area 210 may include preamble data 211. The preamble data 211 may be code information previously agreed in a transmitting end and/or a receiving end. For example, a high-autocorrelation random binary code may be used as the preamble data 211.

A length of codewords of the acoustic data may be set to be 7 bits. Each of the codewords may define a 4-bit cyclic redundancy check (CRC) code. A CRC code 240 may be a method of verifying whether data transmitted through a connection link has an error. The CRC code 240 may use Equation 1 as shown below.

CRC=x⁵+x⁴+x³+x²+x¹+1 [Equation 1]

A text type may have a highest degree of freedom among pieces of additional information transmitted through the ADT encoder 101. The text information may be expressed based on an American standard code for information interchange (ASCII) code, and all combinations of text information may be transmitted.

The header area 220 may include three fields, for example, Type of info 221, Payload Size 222, and No. of Characters 223. The Type of info 221 may indicate a type of additional information. That is, whether the type of additional information is a text type may be verified using the Type of info 221.

The header area 220 may include the Payload Size 222 indicating a size of an area of a bitstream including text data. Text type acoustic data may be set based on a size of text transmitted through the Payload Size 222. Text length information may be required to be transmitted through a field of the No. of Characters 223 in order to set the Payload Size 222.

The header area 220 may include the No. of Characters 223 providing the text length information. A standard of the text type acoustic data may indicate the text length information transmitted through the No. of Characters 223.

The Payload Size 222 may be set to be in a size of codeword corresponding to a multiple of the No. of Characters 223 in the standard of the text type acoustic data. A single codeword may be set to be 7 bits based on an ASCII code length in the standard of the text type acoustic data. A length of the CRC code 240 may be 4 bit with respect to a 7-bit codeword, and used to determine whether each codeword, for example, the ASCII code has an error.

Similarly, the No. of Characters 223 may be 7 bits. Thus, a maximum number of types of characters to be transmitted from a single payload may be 127. Alternatively, a maximum number of types of characters to be transmitted to a single payload may be 127.

Data of an individual field configuring the header area 220 may be transmitted repetitively. This is for stably transmitting information included in the header area 220 and set based on a bit error occurring when transmission is performed through an acoustic channel.

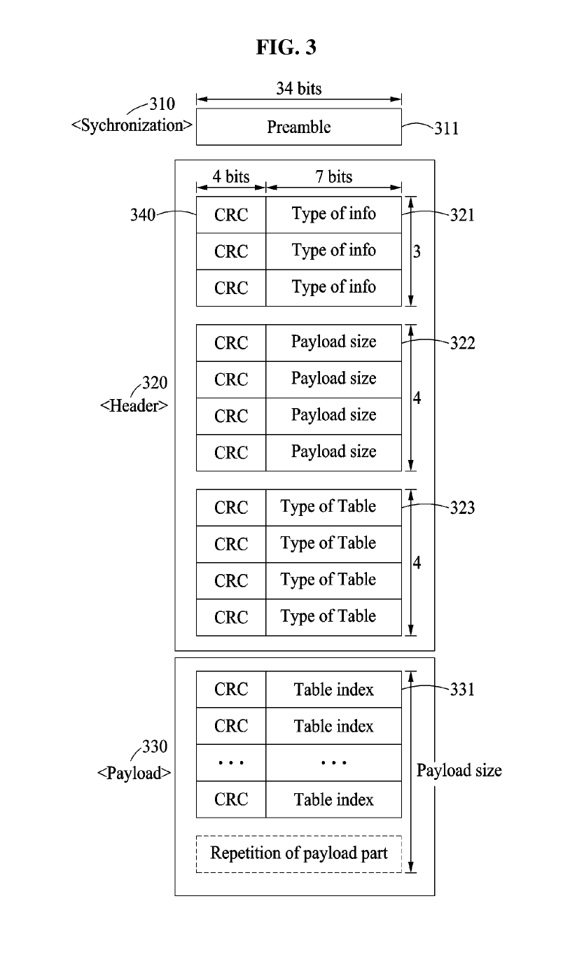

FIG. 3 is a diagram illustrating a structure of a table index type bitstream according to an example embodiment.

A table index type bitstream may include a synchronization area 310 in charge of synchronization, a header area 320 in charge of a header, and a payload area 330 in charge of a payload.

The synchronization area 310 may include preamble data 311. The preamble data 311 may be code information previously agreed in a transmitting end and/or a receiving end. For example, a high-autocorrelation random binary code may be used as the preamble data 311.

A length of codewords of the acoustic data may be set to be 7 bits. Each of the codewords may define a 4-bit CRC code. A CRC code 340 may be a method of verifying whether data transmitted through a connection link has an error. The CRC code 340 may use Equation 2 as shown below.

CRC=x⁵+x⁴+x³+x²+x¹+1 [Equation 2]

A table index type may indicate a case in which transmitted additional information transmits a value of a predetermined table index. The header area 320 may include a field of Type of info 321 indicating a type of additional information. That is, the type of the additional information may be verified using the field of the Type of info 321. The header area 320 may include a field of Payload Size 322 indicating a size of table index data.

A table index may be determined by a service provider. A user terminal may access table data previously defined to provide an additional service based on various pieces of additional information. The field of the Type of info 321 may define a category of a predetermined table. Information about the predetermined table may be identified based on information in the field of the Type of Table 323.

A table index-based additional service, for example, web assess uniform resource locator (URL) information provided in association with the additional information may be constructed as a table in advance. In this example, when a plurality pieces of table information is provided, the web access URL information may be verified through the Type of Table 323. Table index information obtained from the payload area 330 may be used to acquire URL information from the verified table.

Similarly to the text type bitstream 20, bits assigned to the Table index 331 may be 7 bits and thus, 128 indices may be transmitted. Also, in terms of a type of table, 7 bits may be assigned to the Type of Table 323. Thus, up to 128 different pieces of table information may be constructed and other table information may also be applicable.

Data of an individual field configuring the header area 320 may be transmitted repetitively. This is for stably transmitting information included in the header area 320 and set based on a bit error occurring when transmission is performed through an acoustic channel.

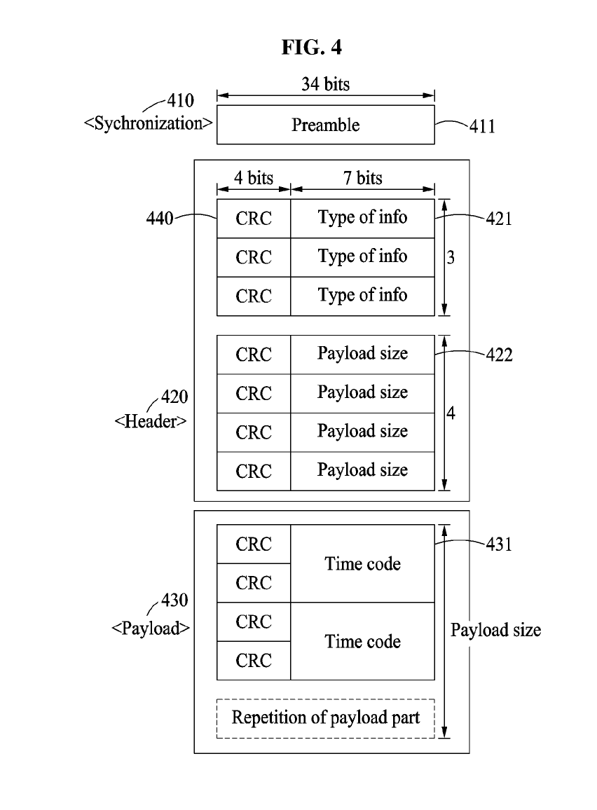

FIG. 4 is a diagram illustrating a structure of a time code type bitstream according to an example embodiment.

A time code type may be applied when transmitted additional information is time information of contents. A time code type bitstream may include a synchronization area 410 in charge of synchronization, a header area 420 in charge of a header, and a payload area 430 in charge of a payload.

The synchronization area 410 may include preamble data 411. The preamble data 411 may be code information previously agreed in a transmitting end and/or a receiving end. For example, a high-autocorrelation random binary code may be used as the preamble data 411.

A length of codewords of the acoustic data may be set to be 7 bits. Each of the codewords may define a 4-bit CRC code. A CRC code 440 may be a method of verifying whether data transmitted through a connection link has an error. The CRC code 440 may use Equation 3 as shown below.

CRC=x⁵+x⁴+x³+x²+x¹+1 [Equation 3]

The header area 420 may include a field of Type of info 421 and a field of Payload Size 422. That is, whether a type of the additional information is a time code may be verified using the field of the Type of info 421. The header area 420 may include a field of Payload Size 422 indicating a size of an area of a bitstream including a time code.

In contrast to text information and table index information, it is difficult to express a single time code with 7 bits. In one example, a time code may be constructed as 18 bits by adding 17 bits to a 1-bit reserved bit. For example, an 18-bit codeword may be transmitted as shown in Table 1 below.

TABLE 1

| | | |
|---|---|---|
| Hour: 0~23 (5 bits) | Minute: 0~59 (6 bits) | Second: 0~59 (6 bits) |

Similarly to the table index type bitstream 300, an error in 18 bits may be verified using the CRC code 440 with 4 bits.

Data of an individual field configuring the header area 420 may be transmitted repetitively. This is for stably transmitting information included in the header area 420 and set based on a bit error occurring when transmission is performed through an acoustic channel.

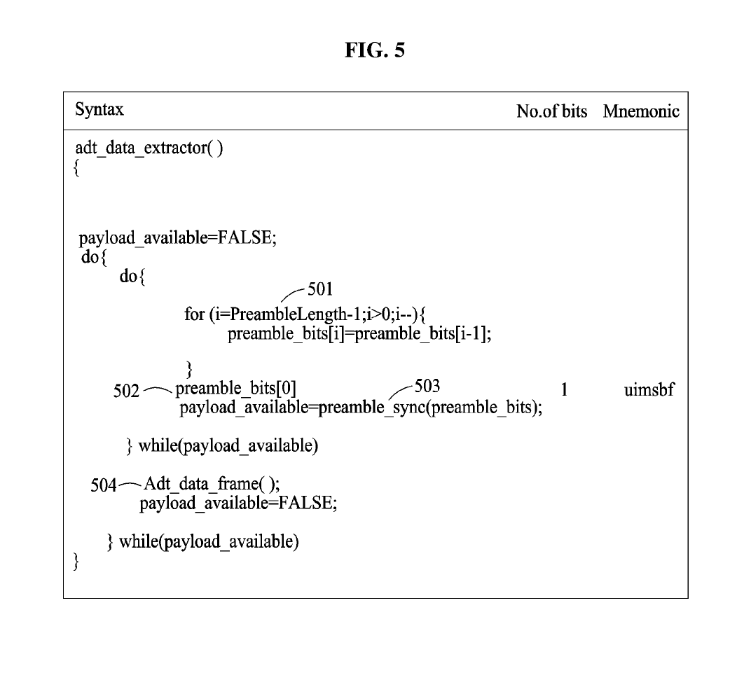

FIG. 5 is a diagram illustrating a syntax of adt_data_extractor according to an example embodiment.

PreambleLength 501 may indicate a bitstream length of preamble data inserted into a head portion of a bitstream for synchronization. The bitstream length of the preamble data may be expressed by up to 34 bits.

Preamble_bits 502 may indicate the preamble data. The preamble data may be a complement bit string including bits {1,1,1,1} of a head/tail portion and may be expressed as shown in Equation 4 below.

$${Preamble}_{bits} = \{ \underbrace{\begin{matrix}1 , 1 , 1 , 1 , 0 , 1 , 0 , 1 , 0 , 1 , 0 , 1 , 0 , 1 , … , \\ 0 , 1 , 0 , 1 , 0 , 1 , 1 , 1 , 1 , 1\end{matrix}}_{preambleLength} \} \qquad [ Equation 4 ]$$

Preamble_sync 503 may be a function of verifying whether a received preamble bitstream is value. When the received preamble bitstream is valid, a synchronization bit string may be retrieved. The received preamble bitstream being valid may indicate that a bitstream error does not occur when transmission is performed through an acoustic channel.

Adt_data_frame 504 may indicate a function of an ADT data frame receiving a transmitted valid data bit string when synchronization of the preamble data is completed.

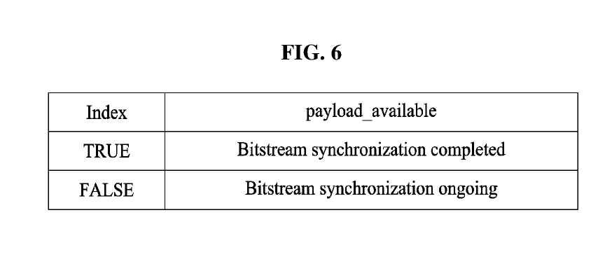

FIG. 6 is a diagram illustrating a definition of payload_available according to an example embodiment.

An index of Payload_available may have two values, TRUE and FALSE. When the value is TRUE, bitstream synchronization may be completed. When the value is FALSE, the bitstream synchronization may be ongoing.

Thus, when the bitstream synchronization is completed, a valid bitstream may be received. Also, when the bitstream synchronization is ongoing, the valid bitstream may not be received.

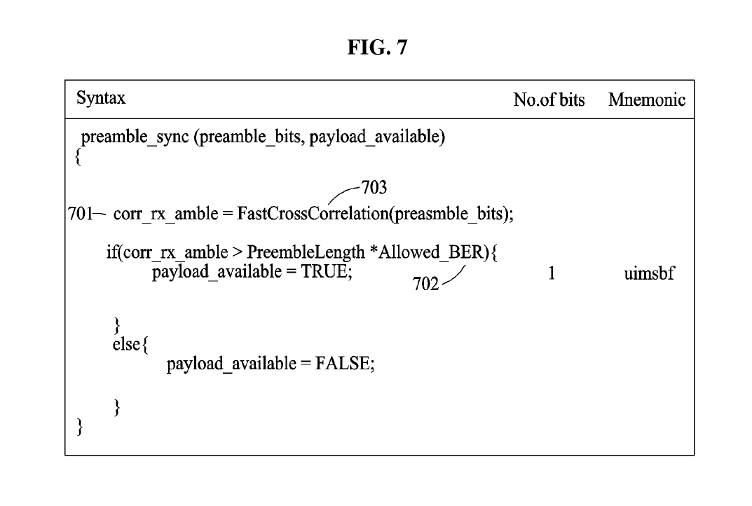

FIG. 7 is a diagram illustrating a syntax of preamble_sync according to an example embodiment.

Corr_rx_amble 701 may be a coefficient representing a correlation between received preamble data and original preamble data. A value of the Corr_rx_amble 701 may be determined in a range from 0 to a PreambleLength value.

Allowed_BER 702 may be a value representing a reliability of synchronization. A value of the Allowed_BER 702 may be determined to be a value ranging between 0 and 1. For example, when a bit error rate (BER) of the received preamble data is allowed to be up to 20%, the value of the Allowed_BER 702 may be set to 0.8. Hereinafter, the bit error rate may also be referred to as a BER.

FastCrossCorrelation 703 may be a function for obtaining a correlation between the received preamble data and the original preamble data. The function for obtaining the correlation may not be defined separately and thus, a general correlation function may also be applicable. Also, a value of correlation may be in a range of the value of the Corr_rx_amble 701.

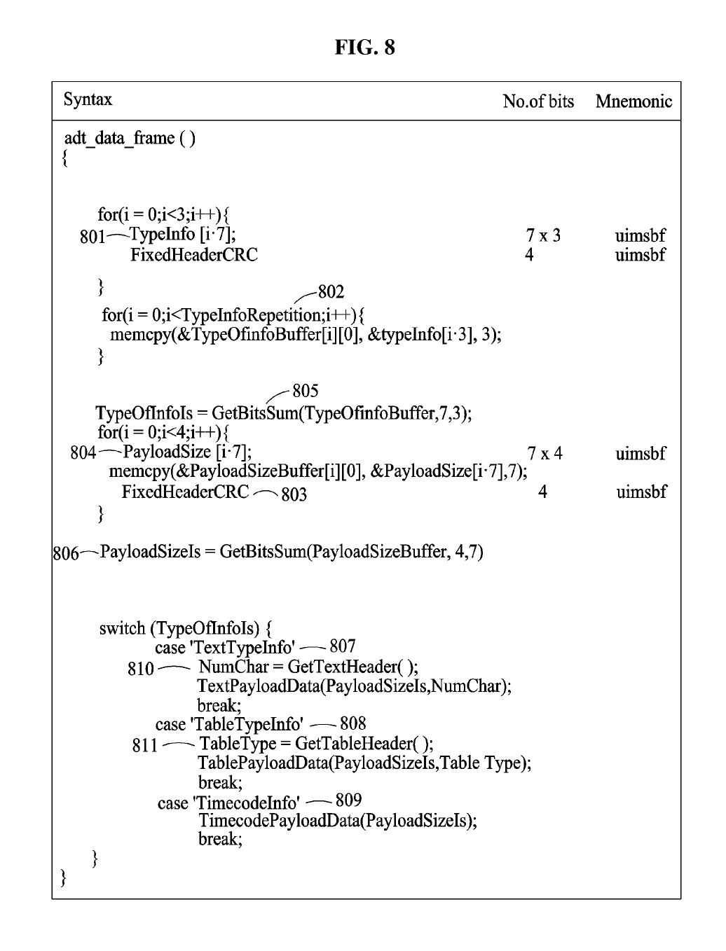

FIG. 8 is a diagram illustrating a syntax of adt_data_frame according to an example embodiment.

Typeinfo 801 may be information included in a header area in a received bitstream. The Typeinfo 801 may be a bitstream received to verify a type of additional information corresponding to the bitstream and expressed by 3 bits.

TypeinfoRepetition 802 may be a constant indicating a number of times that the bitstream corresponding to the type of additional information is transmitted repetitively. The TypeinfoRepetition 802 may not be transmitted separately and may be a constant defined in advance. A default value of the TypeinfoRepetition 802 may be 7 and thus, the transmission may be repeated 7 times.

FixedHeaderCRC 803 may be a value of a CRC code and received in units of 4 bits. PayloadSize 804 may be an array variable for receiving information on a size of a payload. GetBitsSum (A, B, C) 805 may be a function of receiving a repetitively transmitted bitstream, calculating the repetitively transmitted bitstream to be a single piece of valid information, and providing the valid information. In the GetBitsSum 805, A is a received bitstream, B is an iteration count of field data, and C is a number of bits of the field data. PayloadSizels 806 may indicate a size of a bitstream assigned to a payload and a size converted in units of an 11-bit codeword.

TextTypeinfo 807 may be a variable defining a text type when transmitted additional information is in the text type. TableTypeinfo 808 may be a variable defining a table index type when the transmitted additional information is in the table index type. TimeCodeinfo 809 may be a variable defining a time code type when the transmitted additional information is in the time code type.

NumChar 810 may be a variable representing a byte length of valid text information when the transmitted additional information is in the text type. TableType 811 may be table type information providing indication on a table corresponding to an index when the transmitted additional information is in the table index type.

TextPayloadData (A, B) may be a function for loading additional information transmitted based on the text type, A being a payload size calculated in units of 11 bits and B receiving byte-by-byte value length of the text information as a factor. TablePayloadData (A) may be a function for loading additional information transmitted based on the table index type, A receiving the payload size calculated in units of 11 bits as a factor. TimecodePayloadData (A) may be a function for loading additional information transmitted based on the time code type, A receiving the payload size calculated in units of 11 bits as a factor.

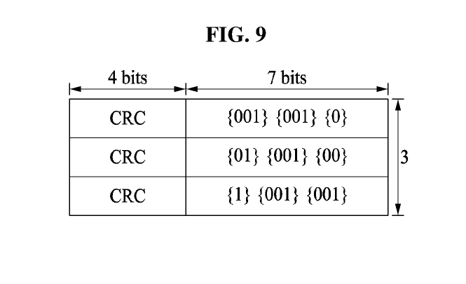

FIG. 9 is a diagram illustrating an example of configuring a type of info bitstream with respect to a table type {001} according to an example embodiment.

Referring to FIG. 9, a field of Type of info may be constructed using the Typeinfo 801 and the TypeinfoRepetition 802. That is, information on a type of additional information may be iterated seven times and transmitted in units of 21 bits. A CRC code may be added by dividing the information on the type of information in units of 7 bits. The information on the type of additional information may be acquired from Table 2 as shown below.

TABLE 2
Definition of TypeOfInfols

| Index | TypeOfInfols |
|---|---|
| 000 | “TextTypeInfo” |
| 001 | “TableTypeInfo” |
| 010 | “TimeCodeInfo” |
| . . . | Reserved |
| 111 | Reserved |

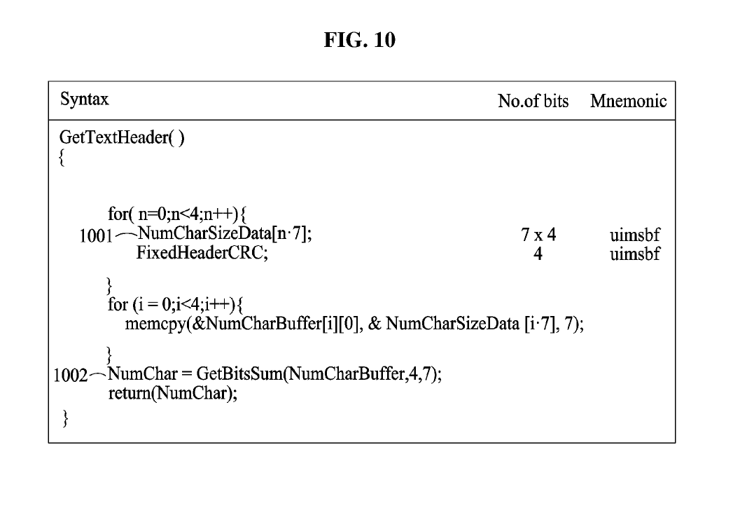

FIG. 10 is a diagram illustrating a syntax of GetTextHeader according to an example embodiment.

NumCharSizeData 1001 may be a syntax for receiving character string length information of transmitted text information. A bitstream transmitted four times in units of 7 bits may be read. NumChar 1002 may indicate a character string length of transmitted additional information.

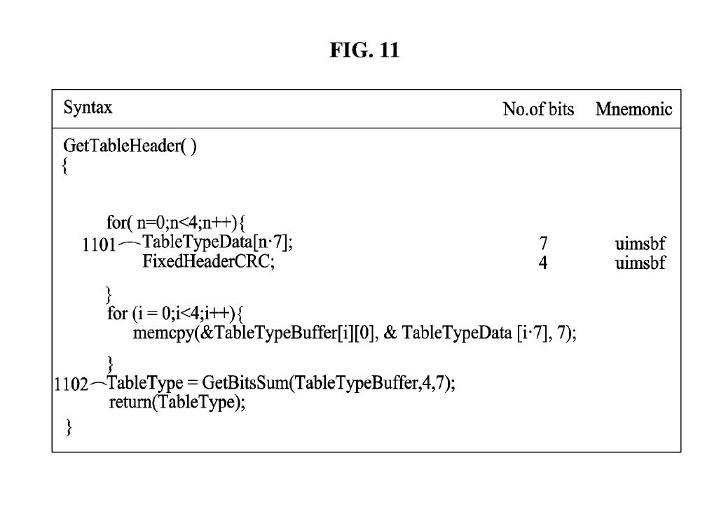

FIG. 11 is a diagram illustrating a syntax of GetTableHeader according to an example embodiment.

TableTypeData 1101 may be a syntax for receiving transmitted table type information. A bitstream transmitted four times in units of 7 bits may be read. TableType 1102 may be a variable representing a transmitted table type.

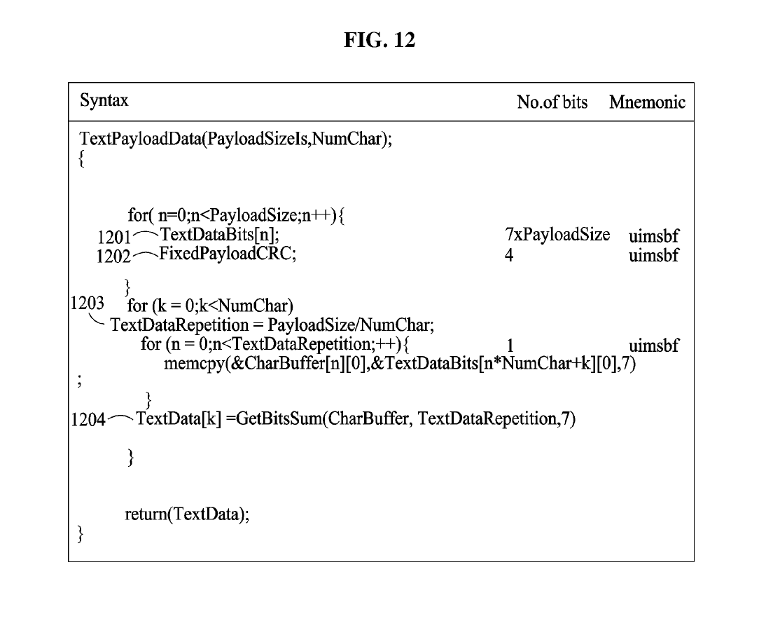

FIG. 12 is a diagram illustrating a syntax of TextPayloadData according to an example embodiment.

TextDataBits 1201 may indicate a two-dimensional array variable in a form of PayloadSizels*7. FixedPayloadCRC 1202 may be a CRC code value of a payload and received as fixed by 4 bits. TextDataRepetition 1203 may indicate a number of times that text information is repetitively inserted into the payload. TextData 1204 may be an array variable for outputting text information that is restored to be in a bitstream structure.

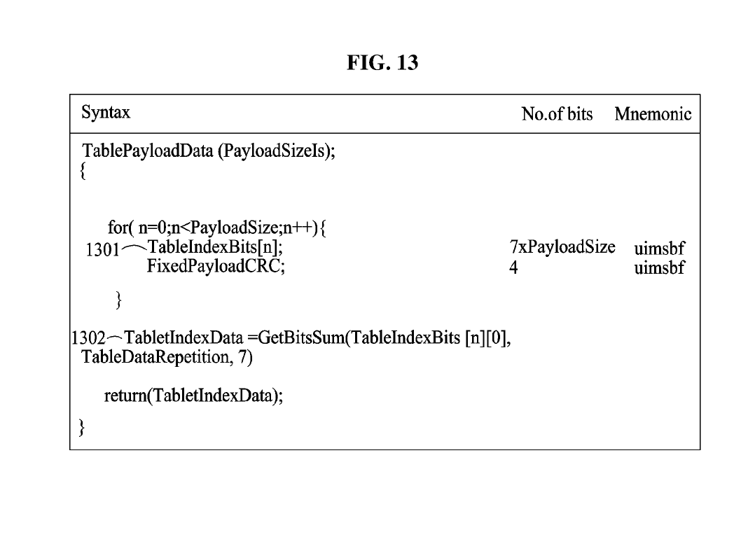

FIG. 13 is a diagram illustrating a syntax of TablePayloadData according to an example embodiment.

TableIndexBits 1301 may be a two-dimensional array variable in a form of PayloadSizels*7 and may load text data in units of 7 bits based on PayloadSizels. TabletIndexData 1302 may be an array variable for storing text information that is restored to be in a bitstream structure to output the text information.

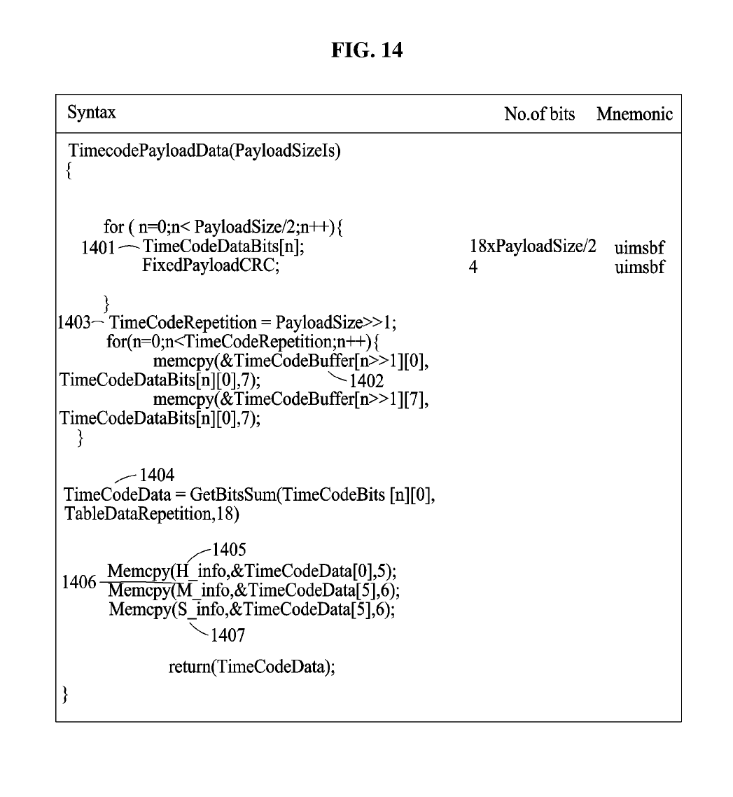

FIG. 14 is a diagram illustrating a syntax of TimecodePayloadData according to an example embodiment.

TimeCodeDataBits 1401 may be a two-dimensional array variable in a form of PayloadSizels/2*18 and may load time code data in units of 18 bits based on PayloadSizels.

TimeCodeBuffer 1402 may be a two-dimensional array that stores PayloadSizels/2 time codes, each being 18 bits. TimeCodeRepetition 1403 may be a number of times that transmission of the time code is repeated and may be the same as PayloadSizels/2. TimeCodeData 1404 may be an array variable for storing time code information that is restored to be in a bitstream structure to output the time code information.

H_info 1405 may be a variable extracting hour information from TimeCodeData and storing the hour information. M_info 1406 may be a variable extracting minute information from the TimeCodeData and storing the minute information. S_info 1407 may be a variable extracting second information from the TimeCodeData and storing the second information.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A bitstream generation method performed by an acoustic data transmission (ADT) encoder, the method comprising:
receiving a first audio signal;
receiving additional information converted into a bitstream; and
transmitting a second audio signal obtained by inserting the bitstream into the first audio signal, to an ADT decoder.

2. The bitstream generation method of claim 1, wherein when the additional information is text information, a text type bitstream for transmitting the text information is generated.

3. The bitstream generation method of claim 1, wherein when the additional information is table index information, a table index type bitstream for transmitting the table index information is generated.

4. The bitstream generation method of claim 1, wherein when the additional information is time information of content, a time information type bitstream for transmitting the time information is generated.

5. A bitstream playing method performed by an acoustic data transmission (ADT) decoder, the method comprising:
receiving, from an ADT encoder, a second audio signal obtained by inserting additional information converted into a bitstream into a first audio signal;
extracting the bitstream from the second audio signal; and
playing additional information by performing conversion on the extracted bitstream.

6. The bitstream playing method of claim 5, wherein when the inserted additional information is text information, a text type bitstream for transmitting the text information is generated.

7. The bitstream playing method of claim 5, wherein when the inserted additional information is table index information, a table index type bitstream for transmitting the table index information is generated.

8. The bitstream playing method of claim 5, wherein when the inserted additional information is time information of content, a time information type bitstream for transmitting the time information is generated.

9. An apparatus for generating a bitstream, the apparatus comprising:
a processor configured to:
receive a first audio signal;
receive additional information converted into a bitstream; and
transmit a second audio signal obtained by inserting the bitstream into the first audio signal, to an acoustic data transmission (ADT) decoder.

10. The apparatus of claim 9, wherein when the additional information is text information, a text type bitstream for transmitting the text information is generated.

11. The apparatus of claim 9, wherein when the additional information is table index information, a table index type bitstream for transmitting the table index information is generated.

12. The apparatus of claim 9, wherein when the additional information is time information of content, a time information type bitstream for transmitting the time information is generated.
